(19) United States
(12) Patent Application Publication
(10) Pub. No.: US 2005/0237682 A1
(43) Pub. Date: Oct. 27, 2005

(54) Novel ESD protection scheme for core devices

(75) Inventors: Yi-Hsun Wu, Hsin-Chu (TW); Jian-Hsing Lee, Hsin-Chu (TW)

Correspondence Address: STEPHEN B. ACKERMAN, 28 DAVIS AVENUE, POUGHKEEPSIE, NY, 12603, US

(73) Assignee: Taiwan Semiconductor Manufacturing Co.

(21) Appl. No.: 10/831,897

(22) Filed: Apr. 26, 2004

(51) Int. Cl. H02H 9/00

(52) U.S. Cl. 361/56

(57) ABSTRACT

A circuit and a method for solving the general problem of protecting core devices in integrated circuits from electrostatic discharge damage is provided. This circuit and a method prevents ESD voltage breakdown of thin oxide field effect transistors which are directly connected to the core Vdd power supply. The embodiments of this invention use inverter buffers using a thick or thin oxide devices at the input to the core circuitry is to be protected. Other embodiments of this invention use pass transistor or transfer gates made with thick or thin oxide devices at the input to the core circuitry is to be protected.

### BACKGROUND OF THE INVENTION

1Field of the Invention

The present invention generally relates to the general problem of protecting core devices in integrated circuits from electrostatic discharge, ESD damage. More particularly, this invention relates to a circuit and a method for preventing ESD voltage breakdown of thin oxide field effect transistors which are directly connected to the core Vdd power supply.

2Description of the Prior Art

FIG. 1 shows a prior art view of a core set of field effect transistors, FETs, which are attached to the core Vdd power supply. As gate oxides get thinner, oxide breakdown occurs more readily and more often. With thin oxide semiconductor technology, oxide breakdown may become a limiting factor on sub-micron technologies. In FIG. 1, it is observed that an electrostatic discharge ESD failure occurs on the dummy core circuits, where the gate is directly connected to core-Vdd. In FIG. 1, gates of devices 110 and 120 are both are tied to the core-Vdd power supply voltage. Device 110 is a p-channel metal oxide semiconductor field effect transistor, PMOS FET. Its source is connected to the core-Vdd power supply 130. Its drain 145 is connected to the drain of device 120. Its gate is connected to the core-Vdd power supply 140.

Device 120 is an n-channel metal oxide semiconductor field effect transistor, NMOS FET. Its source is connected to ground 150. Its drain 145 is connected to ground 150. Its drain 145 is connected to the drain of the PMOS device 110. Its gate is connected to the core-Vdd power supply 140.

FIG. 2a shows a typical core NMOS device connected to a core Vdd pin. 230. NMOS FET devices with thin oxide such as the one in FIG. 2a are very susceptible to being damaged by an Electrostatic Discharge (ESD) event occurring at the core-Vdd I/O pin.

FIG. 2b shows a typical core PMOS device connected to a core Vdd pin. The PMOS devices with thin oxide tolerate about 0.5 volts more than NMOS for ESD events. The gate oxide breakdown voltage of PMOS is roughly 0.5V higher than that of NMOS.

U.S. Pat. No. 6,337,787 B2 (Tang) “Gate-Voltage Controlled Electrostatic Discharge Protection Circuit” describes a circuit which is designed to couple between an input port and an IC device having an inverter coupled to the internal circuit of the IC device for the purpose of protecting the IC against ESD stress.

U.S. Pat. No. 6,356,427 B1 (Anderson) “Electrostatic Discharge Protection Clamp for High-Voltage Power Supply or I/O with High-Voltage Reference” discloses an ESD protection circuit that includes two cascode-connected clamps between the protected pad and a reference voltage conductor and two inverter amplifiers.

U.S. Pat. No. 6,320,735 B1 (Anderson) “Electrostatic Discharge Protection Clamp for High-Voltage Power Supply or I/O with Nominal or High-Voltage Reference” discloses an ESD protection circuit which includes Darlington-connected clamps between the protected I/O pad and a reference voltage conductor, and includes circuitry to prevent leakage.

U.S. Pat. No. 6,353,521 (Gans, et al.) “Device and Method for Protecting an Integrated Circuit During an ESD Event” discloses an integrated circuit and method using a voltage protection circuit interfacing with an input buffer of the integrated circuit.

### SUMMARY OF THE INVENTION

It is an object of the present invention to provide a circuit and a method for solving the general problem of protecting core devices in integrated circuits from electrostatic discharge damage. It is further an object of this invention to provide a circuit and a method for preventing ESD voltage breakdown of thin oxide field effect transistors which are directly connected to the core Vdd power supply.

The objects of this invention are achieved by an electrostatic discharge (ESD) circuit for protecting core devices, in integrated circuit designs having an inverter buffer with a thick oxide device at the input to the core circuitry is to be protected. The thick oxide inverter buffer contains a p-channel metal oxide semiconductor field effect transistor, or PMOS FET, device connected to a core power supply voltage. The thick oxide inverter buffer also contains an NMOS FET device connected to the PMOS FET device. This PMOS FET device has its source connected to the core power supply voltage, its drain connected to a drain of the NMOS device and to an input of circuitry to be protected, and its gate connected to ground and to the gate of the NMOS FET device. The NMOS FET device has its drain connected to the source of the PMOS FET device, and to the input of the circuitry to be protected, with its source connected to ground and its gate connected to ground and to the gate of the PMOS FET device.

In addition, there is an embodiment using a pass or transfer gate, with a thick oxide PMOS device at the input to the core circuitry to be protected from ESD. The thick oxide pass gate contains a PMOS device connected between the core power supply voltage and the input of the circuitry to be protected, from ESD. Also, the thick oxide pass or transfer PMOS FET gate has its source connected to the core power supply voltage, its gate connected to ground and its drain connected to the input of the circuitry to be protected.

Another embodiment of the ESD circuit for protecting core devices in integrated circuit chips uses a resistor at the input to the core circuitry to be protected from ESD. This resistor is connected between the core power supply voltage and the input of the circuitry to be protected.

Still another embodiment of this invention uses an inverter buffer using a thin oxide device at the input to the core circuitry is to be protected. The thin oxide inverter buffer contains a p-channel metal oxide semiconductor field effect transistor, or PMOS FET, device connected to a core power supply voltage. The thin oxide inverter buffer contains an NMOS FET device connected to the PMOS FET device. This PMOS FET device has its source connected to the core power supply voltage, its drain connected to a drain of the NMOS device and to an input of circuitry to be protected, and its gate connected to ground and to the gate of the NMOS FET device. The NMOS FET device has its drain connected to the source of the PMOS FET device, and to the input of the circuitry to be protected, its source connected to ground and its gate connected to ground and to the gate of the PMOS FET device.

Another thin oxide embodiment of this invention utilizes a pass or transfer gate using thin oxide PMOS device at the input to the core circuitry to be protected from ESD. The thin oxide pass gate contains a PMOS device connected between the core power supply voltage and the input of the circuitry to be protected. The thin oxide pass or transfer PMOS FET gate has its source connected to the core power supply voltage, its gate connected to ground and its drain connected to the input of said circuitry to be protected.

The above and other objects, features and advantages of the present invention will be better understood from the following detailed description taken in conjunction with the accompanying drawings.

### BRIEF DESCRIPTION OF THE DRAWINGS

FIG. 1 shows a prior art circuit.

FIG. 2a shows a prior art diagram of a circuit whose NMOS device is vulnerable to ESD breakdown.

FIG. 2b shows a prior art diagram, used to illustrate that PMOS devices are generally less vulnerable to ESD breakdown.

FIG. 2c shows a general circuit diagram which illustrates the main embodiment of this invention.

FIG. 3 shows a detailed circuit diagram of the main embodiment of this invention.

FIG. 4 shows a detailed circuit diagram of a second embodiment of this invention.

FIG. 5 shows a detailed circuit diagram of a third embodiment of this invention.

### DESCRIPTION OF THE PREFERRED EMBODIMENT

In the embodiments which follow, the goal is to prevent the high voltage effects caused by Electrostatic discharge (ESD) from reaching the devices which have gate oxides which are vulnerable to breakdown. The embodiments include the techniques of isolation and voltage sharing. The use of thicker oxide devices in the gates which interface to the core-Vdd nodes is a technique used to buffer the more sensitive internal gate devices. Thicker oxides offer enhanced voltage breakdown protection against the high voltages generated by ESD events.

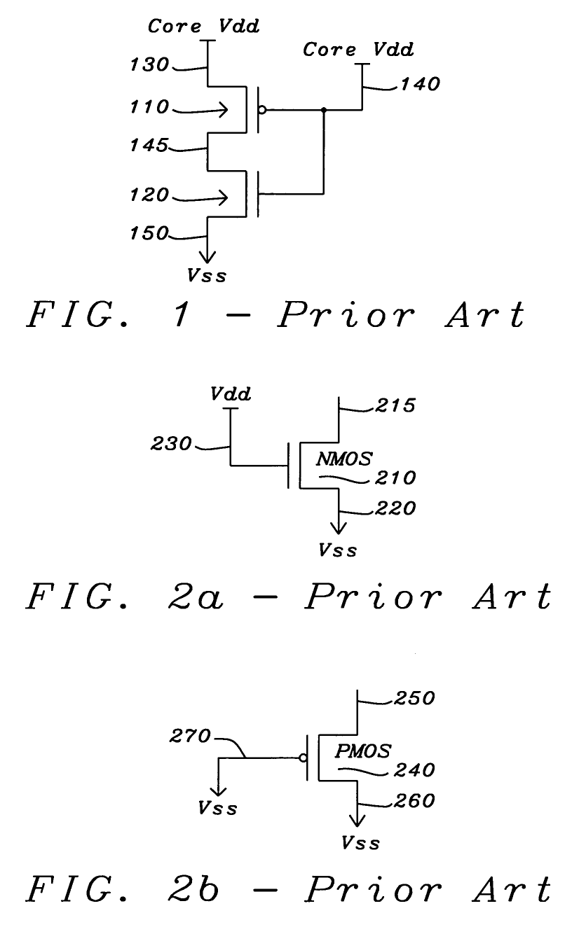

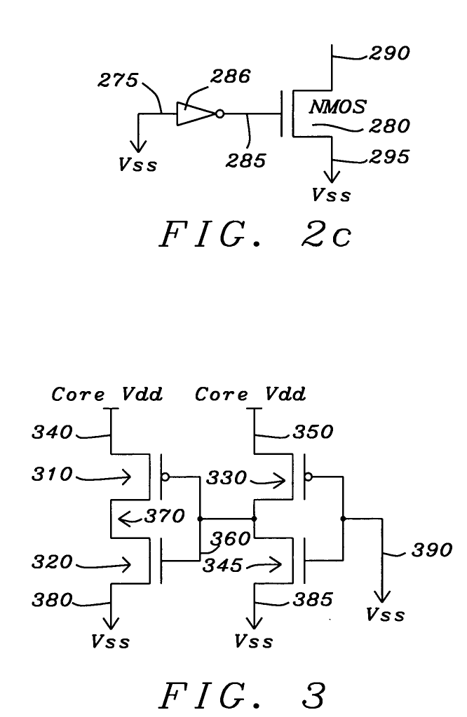

FIG. 2c is a simple circuit diagram illustrating an embodiment of this invention. The NMOS FET device 280, which is to be protected from Electrostatic Discharge, is shown. Its drain is 290. Its source is connected to ground 295. Its gate 285 is connected to the output of an inverter 286. The input of the inverter 275 is connected to ground. The inverter 286 serves to protect the thin oxide NMOS device 280.

In FIG. 2c, the inverter 286 is inserted between the core Vdd and the core Vss Input/Output pad, and the most vulnerable gate oxide of device 280. The function of the circuit in FIG. 2c is identical to the prior art circuit shown in FIG. 2a. In FIG. 2a, the gate of the NMOS device 210 is tied directly to the core Vdd 230 which could be a source of electrostatic discharge (ESD). In FIG. 2c, the input of the inverter 286 is tied to ground. This generates a high voltage at the input node 285 of NMOS device 280. The inverter ‘shields’ and protects the gate oxide of device 280 from ESD on node 275.

FIG. 3 shows a full circuit diagram of the function illustrated in FIG. 2c. The circuit to be protected is made up of devices 310 and 320. Device 310 is a PMOS FET whose source 340 is connected to the core Vdd power supply. Its drain 370 is connected to the drain of the NMOS device 320. Its gate is connected to the gate of the NMOS 320 device. Its gate is also connected to the output 360 of the protective inverter.

Device 320 is an NMOS device whose drain 370 is connected to the source of PMOS device 310. Its source is connected to ground 380. Its gate is connected to the gate of PMOS device 310 and to the output 360 of the protective inverter.

The protective inverter whose output is 360 has a PMOS device 330 and a NMOS device 345, as shown in FIG. 3. The PMOS device 330 has its source 350 connected to the core-Vdd power supply. Its drain is connected to the drain of the NMOS device 345. Its gate is connected to the gate of the NMOS device 345 and to ground or the Vss voltage 390.

The NMOS device 345 has its drain connected to the drain of the PMOS device 330. Its source is connected to ground or Vss 385. Its gate is connected to the gate of PMOS device 330 and to ground or Vss 390.

FIG. 3 shows a device level circuit implementation of the circuit of FIG. 2c. The inverter which is made up of PMOS device 330 and NMOS device 340 is inserted between the ground or Vss node 390 and the vulnerable gate oxides at node 360. The core Vdd node 350 and the ground node 390 are source points for ESD. The inverter devices 330 and 345 shield gate node 360 from this ESD. This first embodiment can use an inverter having devices with oxides of various thicknesses compared to the oxides of the devices to be protected.

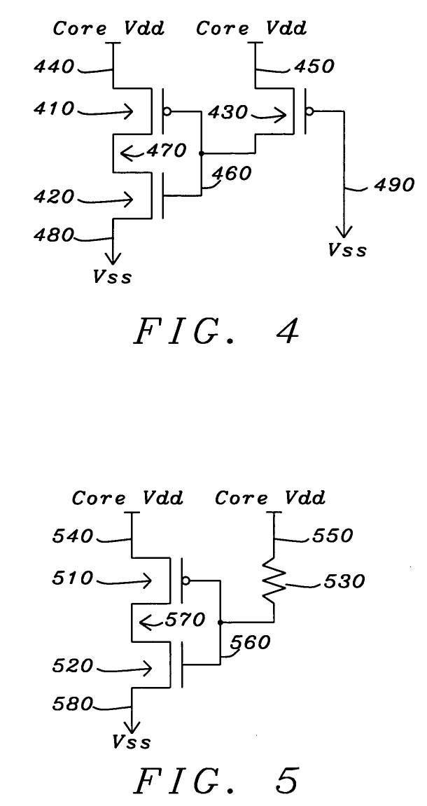

FIG. 4 shows a full circuit diagram of a second embodiment of the function illustrated in FIG. 2c. The circuit to be protected is made up of devices 410 and 420. Device 410 is a PMOS FET whose source 440 is connected to the core Vdd power supply. Its drain 470 is connected to the drain of the NMOS device 420. Its gate is connected to the gate of the NMOS 420 device. Its gate is also connected to the output 460 of the protective pass transistor or transfer gate 430.

Device 420 is an NMOS device whose drain 470 is connected to the source of PMOS device 410. Its source is connected to ground 480. Its gate is connected to the gate of PMOS device 410 and to the output 460 of the protective transfer gate 430.

The protective transfer gate 430 whose output is 460 has a PMOS device 430, as shown in FIG. 4. The PMOS device 430 has its source 450 connected to the core-Vdd power supply. Its drain is connected to the gates of both the PMOS device 410 and the NMOS device 420. Its gate is connected to ground or the Vss voltage supply 490.

In FIG. 4, transfer device 430 protects the thin oxide of the gates of PMOS device 410 and NMOS device 420 from ESD on the core Vdd node 450. The gate of PMOS device 430 is tied to ground 490. This keeps device 430 always ‘ON’. The thin gate oxide of devices 410 and 420 are protected from ESD on node 450. This second embodiment can use a pass transistor or transfer gate having oxides of various thicknesses compared to the oxides of the devices to be protected.

FIG. 5 shows a full circuit diagram of a third embodiment of the function illustrated in FIG. 2c. The circuit to be protected is made up of devices 510 and 520. Device 510 is a PMOS FET whose source 540 is connected to the core Vdd power supply. Its drain 570 is connected to the drain of the NMOS device 520. Its gate is connected to the gate of the NMOS 520 device. Its gate is also connected to the output 560 of the protective resistor 530.

Device 520 is an NMOS device whose drain 570 is connected to the source of PMOS device 510. Its source is connected to ground 580. Its gate is connected to the gate of PMOS device 510 and to one node 560 of the protective resistor 530. The protective resistor whose one node is 430 whose other node is attached to the core Vdd power supply 550.

In FIG. 5, the purpose of the protective resistor 530 is to cause any ESD voltage at the core Vdd node 550 to be “dropped” across the resistor 530. If a large percentage of the ESD voltage is “dropped” across resistor 530, there will be less damaging ESD transmitted to the oxides of devices 510 and 520.

The advantage of this invention is that it provides a novel ESD protection scheme for deep sub-micron technology core devices. It is also an advantage that this invention can be implemented without changes to the manufacturing process, since simple inverters or resistors can be added to existing integrated circuit die. The varied embodiments described above allow for wider use of this invention in several types of integrated circuits.

While the invention has been described in terms of the preferred embodiments, those skilled in the art will recognize that various changes in form and details may be made without departing from the spirit and scope of the invention.

1. An electrostatic discharge circuit for protecting core devices in integrated circuit chips comprising:
an inverter buffer using a device having an oxide thicker than devices to be protected.

2. The ESD circuit for protecting core devices in integrated circuit chip of claim 1 wherein said inverter buffer using a device having an oxide thicker than devices to be protected comprises a p-channel metal oxide semiconductor field effect transistor, PMOS FET device connected to a core power supply voltage.

3. The ESD circuit for protecting core devices in integrated circuit chip of claim 2 wherein said thick oxide inverter buffer contains an NMOS FET device connected to said PMOS FET device.

4. The ESD circuit for protecting core devices in integrated circuit chip of claim 3 wherein said PMOS FET device has its source connected to said core power supply voltage, its drain connected to a drain of said NMOS FET device and to an input of circuitry to be protected, and its gate connected to ground and to the gate of said NMOS FET device.

5. The ESD circuit for protecting core devices in integrated circuit chip of claim 4 wherein said NMOS FET device has its drain connected to said source of said PMOS FET device, and to said input of circuitry to be protected, its source is connected to ground and its gate is connected to ground and to said gate of said PMOS FET device.

6. An ESD circuit for protecting core devices in integrated circuit chips comprising:
a pass or transfer gate using a PMOS device having an oxide thicker than devices to be protected from ESD.

7. The ESD circuit for protecting core devices in integrated circuit chips of claim 6 wherein said transfer gate using a PMOS device having an oxide thicker than devices to be protected from ESD contains said PMOS device which is connected between a core power supply voltage and an input of said circuitry to be protected from ESD.

8. The ESD circuit for protecting core devices in integrated circuit chips of claim 7 wherein said said transfer gate using a PMOS device having an oxide thicker than devices to be protected from ESD has its source connected to said core power supply voltage, its gate connected to ground and its drain connected to said input of said circuitry to be protected, from ESD.

9. An ESD circuit for protecting core devices in integrated circuit chips comprising:
a resistor at the input to the core circuitry to be protected from ESD.

10. The ESD circuit for protecting core devices in integrated circuit chips of claim 9 wherein said resistor is connected between a core power supply voltage and said input to the core circuitry to be protected from ESD.

11. A method of protecting core devices in integrated circuits from electrostatic discharge, ESD, comprising the steps of:
providing an inverter buffer using a device having an oxide thicker than devices to be protected,

12. The method of protecting core devices in integrated circuits from electrostatic discharge, ESD of claim 11 wherein said inverter buffer using a device having an oxide thicker than devices to be protected contains a p-channel metal oxide semiconductor field effect transistor, PMOS FET device connected to a core power supply voltage.

13. The method of protecting core devices in integrated circuits from electrostatic discharge, ESD of claim 12 wherein said inverter buffer using a device having an oxide thicker than devices to be protected contains an NMOS FET device connected to said PMOS FET device.

14. The method of protecting core devices in integrated circuits from electrostatic discharge, ESD of claim 13 wherein said PMOS FET device has its source connected to said core power supply voltage, its drain connected to a drain of said NMOS FET device and to an input of circuitry to be protected, and its gate connected to ground and to the gate of said NMOS FET device.

15. The method of protecting core devices in integrated circuits from electrostatic discharge, ESD of claim 14 wherein said NMOS FET device has its drain connected to said source of said PMOS FET device, and to said input of circuitry to be protected, its source is connected to ground and its gate is connected to ground and to said gate of said PMOS FET device.

16. A method of protecting core devices in integrated circuits from electrostatic discharge, ESD, comprising the steps of:
providing a resistor at an input to core circuitry to be protected from ESD.

17. The method of protecting core devices in integrated circuits from electrostatic discharge, ESD of claim 16 wherein said resistor is connected between a core power supply voltage and said input to core circuitry to be protected from ESD.
